(19) United States
(12) Patent Application Publication
(10) Pub. No.: US 2004/0018069 A1
(43) Pub. Date: Jan. 29, 2004

(54) Self-drilling/self-tapping screw

(75) Inventor: Tsung-Cheng Lai, Kaohsiung (TW)

Correspondence Address: Bacon & Thomas, 625 Slaters Lane - 4th Floor, Alexandria, VA, 22314, US

(73) Assignee: Hsiao Kang Shan Screw Co., Ltd, Kaohsiung (TW)

(21) Appl. No.: 10/206,225

(22) Filed: Jul. 29, 2002

(51) Int. Cl. F16B 25/10

(52) U.S. Cl. 411/387.1

(57) ABSTRACT

A self-drilling/self-tapping screw comprises a shank having a plurality of self-tapping thread convolutions thereon and a head on an end of the shank. The shank further includes a longitudinal axis about which the shank rotates and an entering end portion on another end thereof. The entering end portion comprises a sharp pointed tip substantially located on the longitudinal axis of the shank, a first cutting edge has a first acute angle with the longitudinal axis of the shank, and a second cutting edge having a second acute angle with the longitudinal axis of the shank, the second acute angle being smaller than the first acute angle. In an embodiment, a groove is provided in the entering end portion to increase the cutting speed.

### BACKGROUND OF THE INVENTION

1. Field of the Invention

The present invention relates to a self-drilling/self-tapping screw that includes a groove in an entering end portion such that the tapping efficiency is improved and a force-saving effect is obtained when the self-drilling/self-tapping screw is driven by a manual tool to fix a workpiece in place.

2. Description of the Related Art

Self-drilling/self-tapping screws are generally used in construction of, e.g., a metallic ceiling in which the worker must proceed with fixing of screws at a high place. The overall time for the construction could be shortened and the work would be less labor-intensive if the time for fixing the respective screw is shortened. FIGS. 1 and 2 of the drawings illustrate a conventional self-drilling/self-tapping screw 9 designed by the applicant. The screw 9 includes an entering end portion or drill portion 90 having a first cutting edge 91 and a second cutting edge 92. A slow cutting portion 921 in the form of a groove is provided in the second cutting edge 92 to improve the tapping efficiency. However, undesired abrasion was found in a joint edge 922 of the second cutting edge 92. This is because the recession or indentation of the slow cutting portion 921 causes an increase in the cutting depth such that the joint edge 922 that was designed to have a relatively small angle for avoiding contact with the workpiece is in abrasive contact with the workpiece (see FIG. 3). As a result, the cutting depth “a” of the first cutting edge 91 is impeded by the abrasive contact between the joint edge 922 and the workpiece. Further, the area of the abrasive contact between the joint edge 922 and the workpiece is relatively large and thus increases the labor of the worker for overcoming the friction therebetween.

U.S. Pat. No. 4,114,508 to Jeal issued on Sep. 19, 1978 discloses a self-drilling/self-tapping screw. As shown in FIGS. 4 and 5, the self-drilling/self-tapping screw 8 of Jeal comprises an entering end portion having a first cutting edge 81 and a second cutting edge 82. Trailing the first cutting edge 81 is a flat face 7. The leading end of the first cutting edge 81 is provided by a first sharp pointed tip 80, and the leading end of the second cutting edge 82 is provided by a second sharp pointed tip 70. Between the first tip 80 and the second tip 70 is a small gap 24. However, the tips 80 and 70 are apt to be broken. Further, as illustrated in FIG. 5, a first joint edge 811 and a second joint edge 821 respectively on the first cutting edge side and the second cutting edge side are designed in a manner similar to the conventional screw shown in FIGS. 1 through 3. As a result, the joint edges 811 and 821 would be in contact with the workpiece and thus impede the cutting operation of the first cutting edge 81 and the second cutting edge 82. Further, exhaustion of the metal dust generated during cutting is also impeded, which slows down the cutting speed and increases the labor of the worker due to friction.

### SUMMARY OF THE INVENTION

It is the primary object of the present invention to provide a self-drilling/self-tapping screw that includes a groove in a drill portion such that the tapping efficiency is improved and a force-saving effect is obtained when the self-drilling/self-tapping screw is driven by a manual tool to fix a workpiece in place.

In accordance with a first aspect of the invention, a self-drilling/self-tapping screw comprises a shank having a plurality of self-tapping thread convolutions thereon and a head on an end of the shank. The shank further includes a longitudinal axis about which the shank rotates and an entering end portion on another end thereof. The entering end portion comprises a sharp pointed tip substantially located on the longitudinal axis of the shank, a first cutting edge has a first acute angle with the longitudinal axis of the shank, and a second cutting edge having a second acute angle with the longitudinal axis of the shank, the second acute angle being smaller than the first acute angle.

In accordance with a second aspect of the invention, a self-drilling/self-tapping screw comprises a shank having a plurality of self-tapping thread convolutions thereon and a head on an end of the shank. The shank further includes a longitudinal axis about which the shank rotates and an entering end portion on another end thereof. The entering end portion comprises a sharp pointed tip substantially located on the longitudinal axis of the shank, a first cutting edge located on a side of the sharp pointed tip, and a second cutting edge located on the other side of the sharp pointed tip opposite to the side of the sharp pointed tip.

The first cutting edge is inclined to the longitudinal axis of the shank. A first peripheral face extends from the first cutting edge along a peripheral direction of the entering end portion and has a first joint edge. The second cutting edge is inclined to the longitudinal axis of the shank. A second peripheral face extending from the second cutting edge along the peripheral direction of the entering end portion and includes a second joint edge. The second peripheral face includes a slow cutting portion in the form of a recessed portion that extends from the second cutting edge through the second joint edge, thereby defining a groove in the second peripheral face.

Due to provision of a slow cutting portion in the self-drilling/self-tapping screw in accordance with the present invention, the second joint edge would not interfere with cutting of the first cutting edge. Thus, the tapping speed of the self-drilling/self-tapping screw in accordance with the present invention is increased.

Other objects, specific advantages, and novel features of the invention will become more apparent from the following detailed description and preferable embodiments when taken in conjunction with the accompanying drawings.

### BRIEF DESCRIPTION OF THE DRAWINGS

FIG. 1 is a partial perspective view of a conventional self-drilling/self-tapping screw.

FIG. 2 is a partial perspective view of the conventional self-drilling/self-tapping screw from another side.

FIG. 3 is a sectional view taken along plane 3-3 in FIG. 1, illustrating cutting of the conventional self-drilling/self-tapping screw.

FIG. 4 is a sectional view of another conventional self-drilling/self-tapping screw.

FIG. 5 is a partial perspective view, in an enlarged scale, of an entering end portion of the conventional self-drilling/self-tapping screw in FIG. 4.

FIG. 6 is a perspective view of a first embodiment of a self-drilling/self-tapping screw in accordance with the present invention.

FIG. 7 is a side view of the self-drilling/self-tapping screw in FIG. 6.

FIG. 8 is an end view of the self-drilling/self-tapping screw in FIG. 6.

FIG. 9 is a sectional view taken along plane 9-9 in FIG. 8.

FIG. 10 is a sectional view taken along plane 10-10 in FIG. 7, illustrating cutting of the self-drilling/self-tapping screw in accordance with the present invention.

FIG. 11 is a sectional view taken another plane, illustrating cutting of the self-drilling/self-tapping screw in accordance with the present invention.

FIG. 12 is a perspective view illustrating a second embodiment of the self-drilling/self-tapping screw in accordance with the present invention.

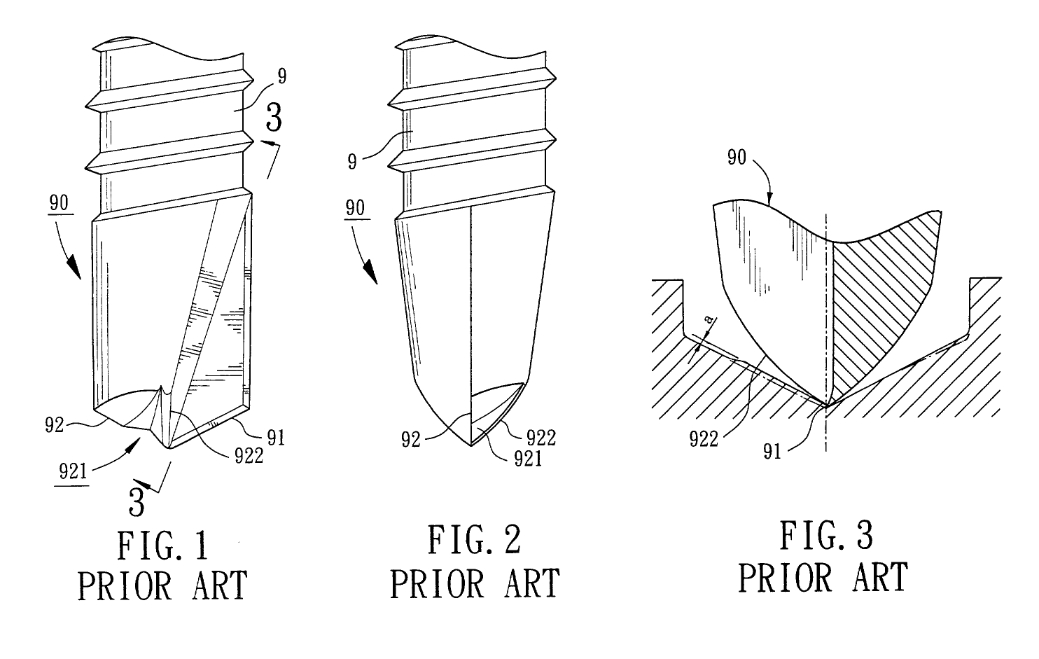

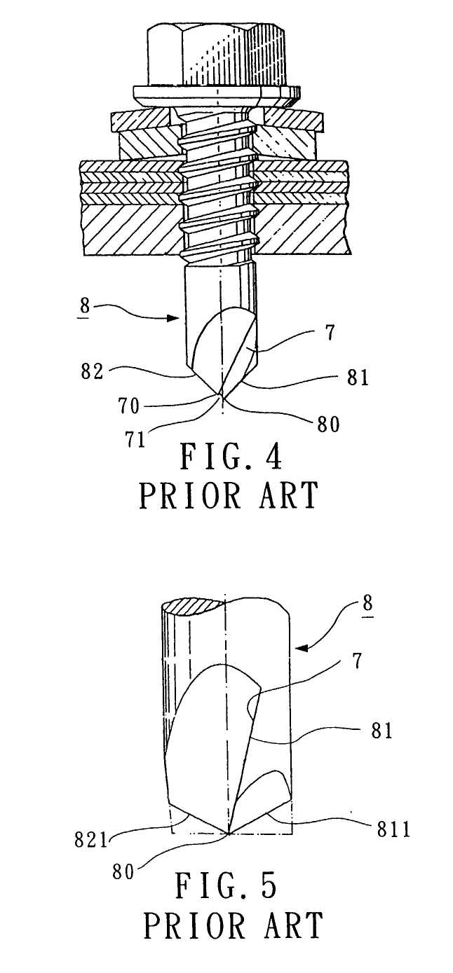

### DETAILED DESCRIPTIONS OF THE PREFERRED EMBODIMENTS

Preferred embodiments in accordance with the present invention will now be described with reference to the accompanying drawings.

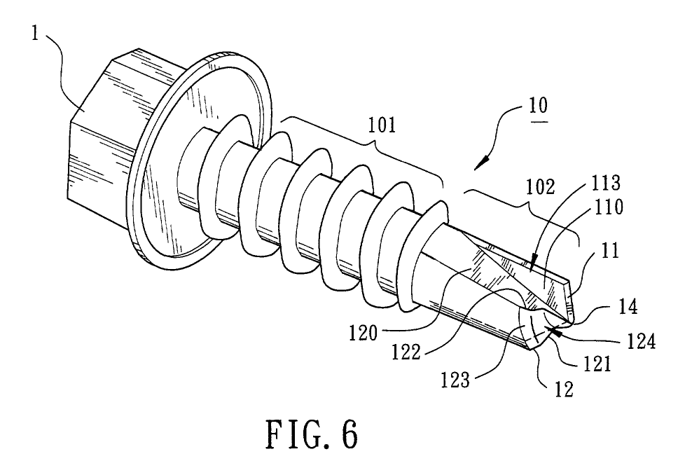

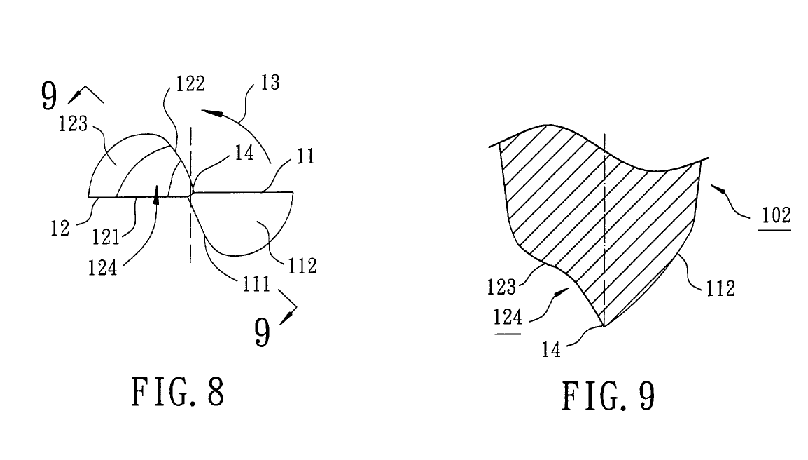

Referring to FIGS. 6 through 9, a first embodiment of a self-drilling/self-tapping screw in accordance with the present invention generally includes a shank 10 and a head 1 on an end of the shank 10. The head 1 is adapted to be engaged with an electric tool for driving the screw about a longitudinal axis 15 of the shank 10 along a direction indicated by the arrow 13 in FIG. 8.

The shank 10 includes a plurality of self-tapping thread convolutions 101 and an entering end portion 102 on the other end thereof. The entering end portion 102 includes a sharp pointed tip 14 that lies on the longitudinal axis 15 of the entering end portion 102. A first cutting edge 11 and a second cutting edge 12 are diametrically formed on two sides of the sharp pointed tip 14, best shown in FIG. 8. The first cutting edge 11 is inclined to the longitudinal axis 15 at an acute angle of about 54.5°. The second cutting edge 12 is also inclined to the longitudinal axis 15 at an acute angle of about 54.5°. The first cutting edge 11 and the second cutting edge 12 provide the cutting function to form a hole in a workpiece, and the self-tapping thread convolutions 101 form threads in a periphery of the hole for fixing the workpiece.

Trailing a side of the first cutting edge 11 is a flat face 110 that lies on a first plane substantially parallel to the longitudinal axis 15, and trailing the second cutting edge 12 is another flat face that lies on a second plane substantially parallel to the longitudinal axis 15. Trailing the other side of the first cutting edge 11 and extending along a peripheral direction of the entering end portion 102 of the shank 10 is a first peripheral face 112 (FIG. 8) having a first joint edge 111. An inclined face (not shown) extends from the first joint edge 111 toward the self-tapping thread convolutions 101.

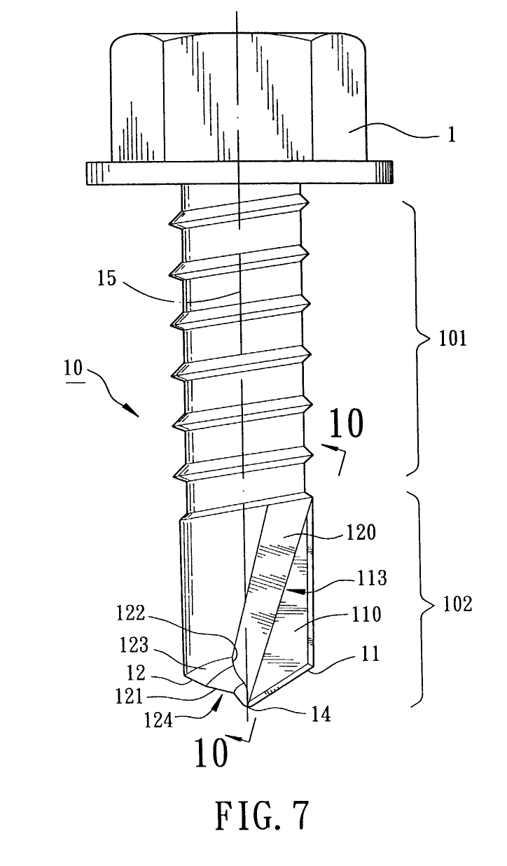

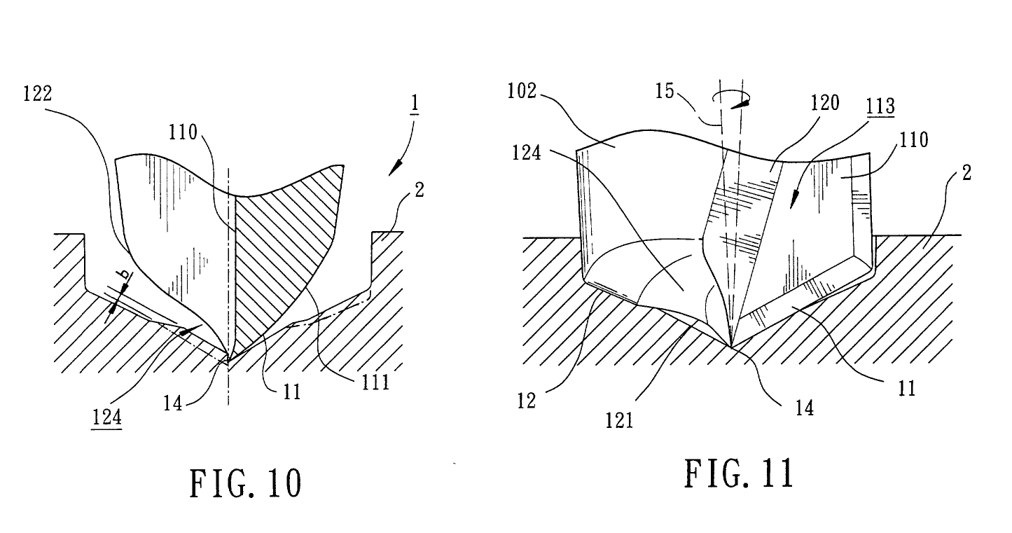

Trailing the other side of the second cutting edge 12 and extending along the peripheral direction of the entering end portion 102 of the shank 10 is a second peripheral face 123 (FIGS. 7 and 8) having a second joint edge 122. An inclined face 120 extends from the second joint edge 122 toward the self-tapping thread convolutions 101. The flat face 110 and the inclined face 120 have an angle of about 110° and together define a dust exhaust groove 113 therebetween. The second peripheral face 123 includes a recessed portion to thereby define a slow cutting portion 121 in the form of a groove 124 surrounding the longitudinal axis 15. The slow cutting portion 121 extends across the second peripheral face 123. Namely, the slow cutting portion 121 extends from the second cutting edge 12 through the second joint edge 122, best shown in FIG. 8. Thus, the angle between a portion of the second cutting edge 12 adjacent to the sharp pointed point 14 and the longitudinal axis 15 is smaller than that between the first cutting edge 11 and the longitudinal axis 15, best shown in FIG. 10.

Referring to FIG. 10, when the self-drilling/self-tapping screw in accordance with the present invention is used to drill a workpiece 2, since a slow cutting portion 121 is provided, the area of the workpiece 2 near the shirt pointed point 14 is cut by the first cutting edge 11. Since the pressure per area unit is increased, the cutting depth of the first cutting edge 11 is increased. The depth “b” in FIG. 10 denotes the predetermined cutting depth after 90° rotation of the first cutting edge 11. Further, due to the indentation of the groove 124, the second joint edge 122 would not abut against a peripheral face of the hole to be drilled. Thus, the cutting depth “b” by each revolution of the screw in accordance with the present invention is greater than the cutting depth “a” (see FIG. 3) by each revolution of the conventional screw. As a result, a hole can be rapidly drilled. Further, since the second joint edge 122 would not be in friction contact with the workpiece 2, weakening of the cutting capability resulting from overtemperature of the workpiece 2 is avoided, and a force-saving effect is provided for the worker due to a reduction of the friction force.

Referring to FIG. 11, when the first cutting edge 11 and the second cutting edge 12 of the screw have thoroughly entered the workpiece, since it is impossible to keep the longitudinal axis 15 of the screw in a fixed axis when the worker manually holding an electric tool for driving the screw. Namely, the screw would revolve about the fixed axis at a small angle, instead of being coincident with the fixed axis. As a result, the first cutting edge 11 cuts the area of the periphery of the hole that is adjacent to the sharp pointed tip 14, and the second cutting edge 12 cuts another area of the periphery of the hole that is distant to the sharp pointed tip 14. It was found in tests that the tapping speed of the screw was increased due to simultaneous cutting of the first cutting edge 11 and the second cutting edge 12.

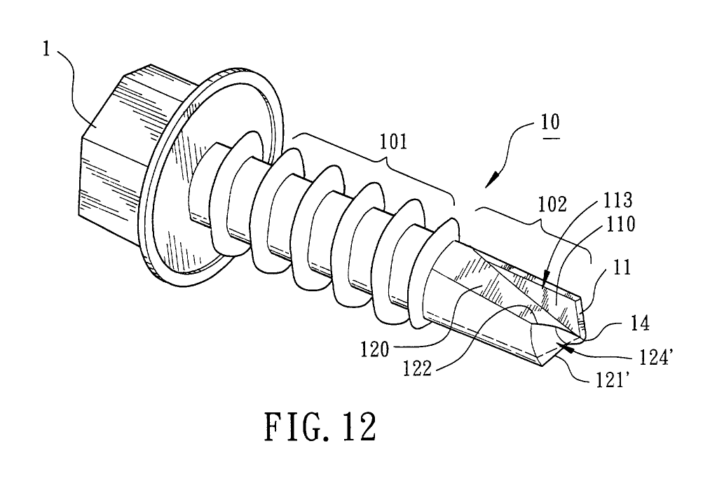

FIG. 12 illustrates a second embodiment of the self-drilling/self-tapping screw in accordance with the present invention, wherein like numerals denote like elements. The only difference between the second embodiment and the first embodiment is that the slow-cutting portion (now designated by 121′) extends to an overall area of the second peripheral face 123. Thus, the angle between the second cutting edge 12 and the longitudinal axis 15 is smaller than that between the first cutting edge 11 and the longitudinal axis 15. As a result, the second joint edge 122 would not interfere with cutting of the first cutting edge 11 due to provision of the groove 124′.

Due to provision of a slow cutting portion in the self-drilling/self-tapping screw in accordance with the present invention, the second joint edge 121 would not interfere with cutting of the first cutting edge 11. Thus, the tapping speed of the self-drilling/self-tapping screw in accordance with the present invention is increased without changing the angle between the first cutting edge 11 and the longitudinal axis 15, and the working time is shortened. The risk of breakage of the first cutting edge 11 having a smaller angle with the longitudinal axis 15 in view of increasing the cutting speed is avoided.

Although the invention has been explained in relation to its preferred embodiment as mentioned above, it is to be understood that many other possible modifications and variations can be made without departing from the scope of the invention. It is, therefore, contemplated that the appended claims will cover such modifications and variations that fall within the true scope of the invention.

What is claimed is:

1. A self-drilling/self-tapping screw comprising a shank having a plurality of self-tapping thread convolutions thereon and a head on an end of the shank, the shank further including a longitudinal axis about which the shank rotates, the shank further including an entering end portion on another end thereof, the entering end portion comprising:
a sharp pointed tip substantially located on the longitudinal axis of the shank;
a first cutting edge having a first acute angle with the longitudinal axis of the shank; and
a second cutting edge having a second acute angle with the longitudinal axis of the shank, the second acute angle being smaller than the first acute angle.

2. A self-drilling/self-tapping screw comprising a shank having a plurality of self-tapping thread convolutions thereon and a head on an end of the shank, the shank further including a longitudinal axis about which the shank rotates, the shank further including an entering end portion on another end thereof, the entering end portion comprising:
a sharp pointed tip substantially located on the longitudinal axis of the shank;
a first cutting edge located on a side of the sharp pointed tip, the first cutting edge being inclined to the longitudinal axis of the shank, a first peripheral face extending from the first cutting edge along a peripheral direction of the entering end portion and having a first joint edge; and
a second cutting edge located on another side of the sharp pointed tip opposite to the side of the sharp pointed tip, the second cutting edge being inclined to the longitudinal axis of the shank, a second peripheral face extending from the second cutting edge along the peripheral direction of the entering end portion and including a second joint edge;
the second peripheral face including a slow cutting portion in the form of a recessed portion that extends from the second cutting edge through the second joint edge, thereby defining a groove in the second peripheral face.

3. The self-drilling/self-tapping screw as claimed in claim 2, wherein the slow cutting portion is adjacent to the sharp pointed tip.

4. The self-drilling/self-tapping screw as claimed in claim 2, wherein the slow cutting portion extends across an overall area of the second peripheral face.
